(19) United States
(12) Patent Application Publication
(10) Pub. No.: US 2019/0391563 A1
(43) Pub. Date: Dec. 26, 2019

(54) ADDITIVE MANUFACTURING-ENABLED PLATFORM FOR MODULAR CONSTRUCTION OF VEHICLES USING DEFINITION NODES

(71) Applicant: DIVERGENT TECHNOLOGIES, INC., Los Angeles, CA (US)

(72) Inventors: Stuart Paul Macey, Los Angeles, CA (US); David Charles O'Connell, Los Angeles, CA (US); Kevin Robert Czinger, Los Angeles, CA (US); Broc William TenHouten, Los Angeles, CA (US); Narender Shankar Lakshman, Los Angeles, CA (US); Jon Paul Gunner, Los Angeles, CA (US); Antonio Bernerd Martinez, Los Angeles, CA (US)

(21) Appl. No.: 16/439,615

(22) Filed: Jun. 12, 2019

Related U.S. Application Data
(60) Provisional application No. 62/688,999, filed on Jun. 22, 2018.

(51) Int. Cl. G05B 19/4099; B33Y 50/02; B22F 3/00; B60K 1/00; B62D 65/00; G06F 17/50

(52) U.S. Cl. CPC G05B 19/4099; B33Y 50/02; B22F 3/008; B33Y 10/00; B62D 65/00; G06F 17/5095; B60K 1/00

(57) ABSTRACT

A platform for building a plurality of vehicle types is disclosed. In an embodiment, a facility may include a processing system for designing a plurality of definition nodes for a vehicle and identifying a relative position for each definition node. Based on the design, the internal volume and other vehicle parameters can be determined. The facility includes a 3-D printer for additively manufacturing the definition nodes. In an embodiment, a plurality of commercial-off-the-shelf (COTS) parts are acquired and the definition nodes are designed to interface with the COTS parts. The facility may also include a station, or primary location where the major portions of the vehicle are assembled. In another embodiment, multiple such geographically-distributed facilities can be used, such that one facility can manufacture a desired vehicle type on behalf of another facility, e.g., in the event of an overflow.

### CROSS-REFERENCE TO RELATED APPLICATIONS

The present application hereby claims the benefit of, and priority to, U.S. Provisional Application No. 62/688,999, filed Jun. 22, 2018, entitled “Additive Manufacturing-Enabled Common Architecture Platform for Modular Construction of Vehicles and Other Transport Structures,” the contents of which is hereby incorporated by reference in its entirety.

### BACKGROUND

### Field

The present disclosure relates generally to vehicle manufacturing, and more specifically to vehicle architecture platforms enabled by additive manufacturing (AM) and modular construction methods for manufacturing a plurality of vehicle types without the constraints and capital expenditures of traditional systems.

### Background

For over a century, vehicles and other transport structures have been built using traditional assembly lines. An assembly line is a manufacturing technique in which the vehicle starts at one end, for example, as a bare chassis. Components (e.g., engine, hood, wheels, etc.) are sequentially added to the chassis as the semi-finished vehicle moves via a conveyor from station to station, until the vehicle is finished at the last station. By moving the semi-finished vehicle progressively from one dedicated station to another, the vehicle can be assembled faster, cheaper and using less manpower than with prior manual assembly techniques.

Production of vehicles using assembly lines has historically been beneficial to the manufacturer and more affordable to the consumer, provided that the vehicles from a single line are limited to a single model or a few similar models. As manufacturers look to make vehicle manufacturing more efficient, flexible, eco-friendly, and economical, coupled with the evolution of consumer demand for different designs of custom transport structures, the historical benefits of assembly lines are being called into question. The lines are typically not capable of accommodating multi-vehicle assembly.

Accommodating new vehicles instead would require a complete redesign of both the vehicles and the line itself. Along with the new vehicle designs, modifying the line necessitates acquiring or building large numbers of disparate parts. Individual parts used in different vehicles can differ in shape, size, number, function, sophistication level, and propulsion type, to name a few. Expensive new tooling for machining custom components for each vehicle model must be acquired. New machinery is needed to build each different vehicle frame, chassis, panels, floors, etc. In short, changing the assembly line to accommodate new vehicles would entail significant capital expenditures that likely cannot be justified, limiting the consumer to the finite category of vehicle options available from a handful of automakers.

### SUMMARY

Several aspects of additive manufacturing-enabled common architecture platform for modular construction of vehicles and other transports structures are disclosed.

In one aspect of the disclosure, a method for manufacturing a vehicle includes designing a plurality of definition nodes, identifying a relative position for each definition node, additively manufacturing the definition nodes, and assembling the vehicle with the definition nodes in the identified positions.

In another aspect of the disclosure, a facility for manufacturing a plurality of vehicle types includes a processing system configured to design a definition node for each section and identify a relative position for each definition node, at least one 3-D printer configured to additively manufacture the definition nodes, and a station for manufacturing one of the plurality of vehicle types using the definition nodes in the identified position.

In another aspect of the disclosure, a plurality of geographically distributed facilities are configured for manufacturing a plurality of vehicle types, each facility including a processing system configured to design a plurality of definition nodes for a vehicle identify a relative position for each definition node, at least one 3-D printer configured to additively manufacture the definition nodes, and a station for manufacturing one of the plurality of vehicle types using the definition nodes in the identified location.

It will be understood that other aspects of methods of producing parts for transport structures will become readily apparent to those skilled in the art from the following detailed description, wherein it is shown and described only several embodiments by way of illustration. As will be realized by those skilled in the art, the parts and methods of producing the parts are capable of other and different embodiments and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of additive manufacturing-enabled common architecture platforms for modular construction of vehicles and other transport structures are now be presented in the detailed description by way of example, and not by way of limitation, in the accompanying drawings, wherein:

FIG. 1 shows an exemplary underbody configuration of a vehicle made according to an embodiment.

FIG. 2 shows an exemplary vehicle with different aperture configurations according to an embodiment.

FIG. 3 shows a conceptual spectrum of various exemplary aperture material features.

FIG. 4 shows an exemplary vehicle broken down into six definition nodes according to an embodiment.

FIGS. 5A-C illustrate three examples of different hybrid/ICE vehicles for which internal volume requirements may differ based on packaging volumes used to accommodate the particular vehicle.

FIG. 6 shows a perspective cross-section view of a definition node (in dashes) coupled to adjacent components in a right passenger section of a vehicle according to an embodiment.

FIG. 7 shows four exemplary product portfolios that may be built using the platform herein-described, governed by factors like underbody construction and vehicle size.

FIG. 8 shows an exemplary configuration of a definition node coupled to a wheel of a vehicle in accordance with an embodiment.

FIG. 9 shows an exemplary flow diagram of a process used by a facility to manufacture different types of vehicles in accordance with an embodiment.

### DETAILED DESCRIPTION

The detailed description set forth below in connection with the appended drawings is intended to provide a description of various exemplary embodiments of manufacturing platforms for producing modular vehicles using additive manufacturing and other technologies, and is not intended to represent the only embodiments in which the invention may be practiced. The terms “exemplary” and “example” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

Assembly lines are common platforms for assembling complex items such as automobiles, other transportation equipment, major type of household appliances and electronic goods. Numerous types of components are manufactured and used in vehicles, the latter of which is broadly construed herein to include numerous types of transport structures such as trucks, trains, motorcycles, boats, aircraft, spacecraft, and the like. Such components may include both “commercial off the shelf” (COTS) and customized components that can serve any one or more of functional, structural or aesthetic purposes within, or as part of, a vehicle.

A platform is disclosed that provides a common architecture for enabling a manufacturer to construct a diverse array of different vehicle types. In one aspect of the disclosure, a desired vehicle type (e.g., hatchback, sedan, SUV, etc.) with a desired size, shape, and feature set is selected for production. During the design phase, the vehicle may be divided into sections. A definition node may be identified for each section. Definition nodes are regions that may be positioned based on factors such as the natural dimensional constraints of the selected vehicle type, the propulsion system type, and are discussed further below.

Based in part on the vehicle's packaging volume as measured using the positioned definition nodes, a plurality of commercial off-the-shelf (COTS) parts suitable for the vehicle's type and characteristics may be acquired. For example, extrusions, tubes, panels, propulsion systems, crash structures, dash equipment and other necessary hardware may obtained from one or more suppliers, or constructed. The COTS vehicle panels may subsequently be cut at the factory in accordance with the required dimensions of the vehicle. In one embodiment, the vehicle uses an electric vehicle (EV) propulsion system, in which case a battery pack is obtained and packaged with the vehicle underbody. Two or more electric motors are also acquired for intended use in regions adjacent the respective wheels of the vehicle that need to be propelled. The definition nodes may be 3-D printed to include the complex portions of the vehicle, including the interfaces/interconnects to each of the plurality of COTS structures with which the definition nodes are configured to interface. Optionally, additional nodes are 3-D printed, e.g., where custom features are desired. Because the platform transfers the interface complexities of the vehicle to definition nodes via the non-design specific 3-D printers, the vehicle assembly process becomes modular in nature. Generally, a “modular” construction is one that is composed of standardized units or sections for easy construction, flexible arrangement, and easy replacement of parts. The definition nodes can be assembled at the factory with the acquired COTS parts in a modular fashion, forming a vehicle with modular characteristics.

The disclosed platform reduces, or altogether eliminates, the need for complex tooling equipment or machining operations at the factory. The modular nature of the platform-based architecture is rendered possible because the intricacies of the vehicle design may be incorporated into the AM structures themselves. The remaining parts can be obtained as COTS parts that are generally already configured to the factory's specifications. Any remaining parts can be acquired or built in-house as is deemed most efficient. As a result, the factory no longer needs to acquire complex and costly tooling or other equipment (e.g., equipment for assembling complex interfaces, electronics/circuitry, etc.) that is dedicated to assembling a single vehicle model.

Further, the flexibility of additive manufacturing (AM) makes it easy for the factory to interface both COTS and custom parts with the vehicle nodes, and to perform minimal refining of the COTS parts to meet their specifications, if necessary. Any burden sustained by the factory for these tasks is typically far less than the contrasting burden on the assembly line manufacturer to perform similar functions using tooling and other inflexible and expensive methods, the latter of which whose vehicles are conventionally not built using the benefits of AM. The in-house production of modified equipment by the assembly line manufacturer requires potentially extraordinary expenses to acquire updated custom tooling for all the different possible vehicle design permutations.

The platform consequently can result in a paradigm shift that redefines the competitive field of prospective manufacturers. That is to say, the platform's benefits can apply not only to major auto-makers with worldwide reach, but also to facilities with limited capital and more modest operational capabilities. The platform may be fully or partially automated.

The above-described platform eliminates the need for the complex vehicle manufacture infrastructure that has heretofore been in place. The platform further extends capabilities for manufacturing diverse vehicle types to prospective manufacturers with smaller operations. For example, the platform can enable the creation of multiple manufacturing facilities in a geographical area. To illustrate the unique benefits of this approach, a conventional assembly-line vehicle manufacturer is considered. If the conventional manufacturer has a traditional plant that supplies vehicles to a certain geographic area and suddenly encounters production problems for whatever reason, the vehicle supply may be altogether halted, likely resulting in significant adverse capital and productivity effects. By contrast, the platform as disclosed herein can enable the creation of multiple smaller footprint factories, each factory to cater to a certain geographical area. Any problems faced by one factory would not have the same negative impact as in the case with traditional factories, since an alternate factory in the same or a nearby geographical area can step up to meet the production demands until the impediment is resolved. As such, the platform enables a distributed production system for automobile manufacturing. This approach makes different business models plausible, such as a franchise or joint development effort, among others.

The platform also enables a manufacturer to deploy a number of small manufacturing plants across a region, wherein each plant is capable of manufacturing a unique portfolio of vehicles, if desired. The platform further promotes innovation in the architecture of vehicles, given the flexibility allotted to manufacturers in identifying definition nodes, selecting packaging volume, and customizing parts using AM.

The above-stated innovation extends to vehicles using electric voltage (EV) propulsion systems, internal combustion engine (ICE) systems, and hybrid systems. By integrating AM structures with EV systems, the vehicle architecture platform disclosed herein can greatly simplify vehicle design, dramatically reducing capital expenditures (“CapEx”), enabling greater vehicle package efficiency in embodiments that eliminate the internal combustion engine (ICE) propulsion system, and allowing much broader user flexibility. Nevertheless, owing to the overall flexibility offered by the platform, it should be understood that vehicles using ICE propulsion and hybrid systems are equally suitable in other configurations. The type of propulsion system may be driven by factors such as price and consumer preference. In certain embodiments, the type of propulsion system may also be driven by government incentives for manufacturers and consumers for producing and operating vehicles with a certain type of propulsion system. The ability to geographically distribute vehicle factories, enabled by the common architecture platform disclosed herein, can prove useful in these embodiments.

The concepts herein are presented with reference to an automobile for illustrative purposes, but the architecture platform herein is equally applicable to the production and assembly of other transport structures including automobiles, trains, busses, motorcycles, metro systems, ships, sea-craft, submarines, spacecraft, and the like.

In sum, the platform provides a common architecture for manufacturers to produce different vehicle portfolios without the limitations inherent in conventional vehicle manufacturing techniques, the latter of which rely principally on heavy capital expenditures for tooling equipment dedicated to producing single vehicle models in assembly-line environments. The platform also takes advantage of the flexibilities of AM to yield highly customizable and geometrically diverse designs that can generally be produced without expensive tooling equipment and with minimal, if any, machining operations.

AM, also known as three-dimensional (3-D) printing, is providing rapidly-changing advances in the various manufacturing arts. Unlike the often costly and inflexible manufacturing techniques (milling, casting, molding, stamping, etc.) to which manufacturers have been restricted for producing vehicle parts, AM can be used to manufacture the same components with complex geometries and sophisticated interfaces, but without the extraordinary costs. Using a non-design specific AM-based infrastructure, 3-D printers can be acquired by manufacturers that seek to develop new components for different products without the need for expensive tooling updates. Instead, the manufacture can design data models for countless varieties of parts using computer-aided-design (CAD) applications. The new parts can then be 3-D printed, e.g., using a powder bed fusion (PBF) based printer, DED (direct energy deposition), or other 3-D printers utilizing alternate 3-D printing techniques. A variety of other 3-D printing technologies may also be employed that may partially overlap with the PBF and DED printing techniques. These include, for example, Stereolithography (SLA), Digital Light Processing (DLP), Laminated Object Manufacturing (LOM), Binder Jetting (BJ), Material Jetting (MJ), and others.

In PBF-based 3-D printing, successive layers of print material (such as metallic powder) are deposited on a substrate in a powder bed region. Between deposition periods, a laser or other energy source fuses and solidifies selected regions of material within a layer. The deposition-fusion process continues, layer-by-layer, until a 3-D object or ‘build piece’ is printed. The unfused powder can subsequently be recycled. The advent of AM in product manufacturing, however, presents a major added alternative, rather than a wholesale substitute, to conventional methods. For example, despite its innumerable advantages, AM requires purchasing the print material and, especially where the factory is at full capacity, AM operations may need to be prioritized. In these cases, it is often advantageous to purchase COTS products as a parallel strategy to AM. In addition to being potentially cost-effective in bulk, COTS products of numerous varieties, and meeting a wide range of specifications, are ubiquitous. Thus, in an embodiment, AM is more often reserved for the central aspects of the vehicle platform including the definition nodes (discussed below), while the wide availability of COTS products and the market presence of numerous competing COTS suppliers provide viable options for the vehicle manufacturer. The combination of AM definition nodes and COTS products enable the vehicle manufacturer to create multi-material structures, which can be advantageously designed to manufacture lighter, stronger, and high-performance vehicles.

In the initial design stages of an aspect of the present architecture, a vehicle profile may be chosen, such as a sedan, sports utility vehicle, a minicar, or custom profile, e.g., developed by the manufacturer based on a consumer order. After the profile is determined, or concurrent with the determination, a propulsion method may be identified. For example, it may be determined whether the vehicle will include an ICE, EV, hybrid, or custom propulsion system.

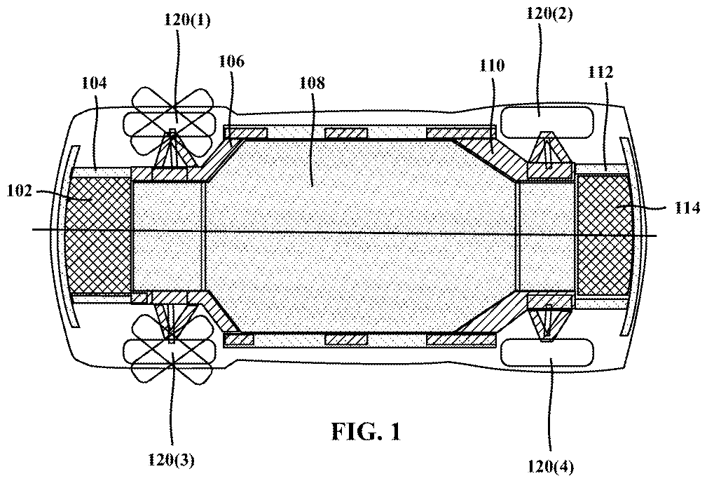

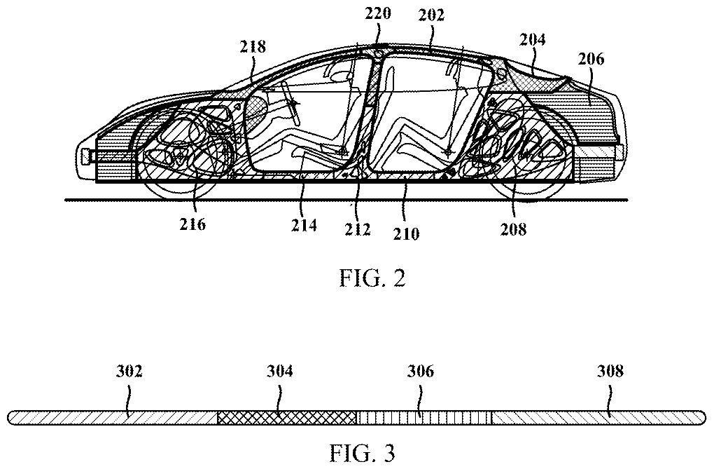

The vehicle profile with the features thus far identified may be represented visually in a CAD or other suitable application. Various COTS parts may be acquired based on the manufacturer needs, i.e. based on the determination of the vehicle profile and the propulsion method as requested by a consumer. The manufacturer may run simulations based on these parts to determine necessary dimensions and other factors. For example, COTS panels may initially be acquired from a supplier. In an embodiment, the COTS panels are cut in house to meet the vehicle profile. Where further dimensional analyses of the vehicle design are needed, the panel cutting may be deferred until a suitable time. Further, where an EV propulsion system is chosen, a COTS battery pack may also be purchased. The battery pack may be separately packaged in advance of the assembly for eventual insertion in the vehicle underbody (see FIGS. 1, 2). It will be appreciated that the order of many of the steps, such as acquisition and assembly of the above COTS parts, may differ in actual practice, and other steps as described herein may be performed first in different implementations.

By integrating AM structures with EV systems, the vehicle architecture platform and embodiments disclosed herein simplify vehicle design, reduce CapEx expenditures, enable greater package efficiency, and allow broader user flexibility. An exemplary configuration incorporating these and other benefits is shown in the illustrations below.

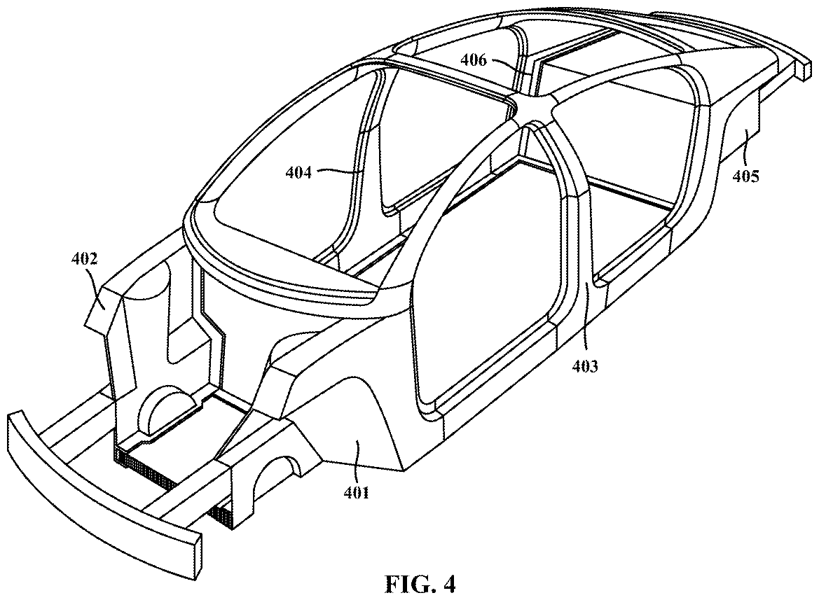

FIG. 1 shows an exemplary underbody configuration of the various sections of a vehicle made according to an embodiment. FIG. 2 shows an exemplary side view of the vehicle of FIG. 1 with different aperture configurations according to an embodiment. FIG. 3 shows a conceptual spectrum of various exemplary aperture material features or textures that are used in the vehicle of FIGS. 1 and 2.

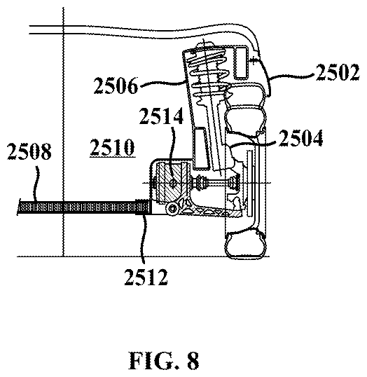

The underbody configuration of FIG. 1 includes front crash structure 104, front corner “steer” node 106, rear corner “drive” node 110, rear crash structure 112, rear tub 114, front tub 102 and floor structure 108. The opposite side of the underbody includes similar nodes, crash structures, etc., and are omitted from specific reference to avoid unduly obscuring the concepts of the disclosure. The wheels are represented by 120(1)-(4). The battery pack and associated electronics may also be included in the underbody configuration. In an embodiment, the battery and/or electric motor may be compactly positioned in the underbody areas beneath and adjacent a wheel and the A and C pillars (see FIG. 2, FIG. 8). This compact configuration may advantageously provide additional volume (see ref no. 2510, FIG. 8 and associated text) or occupants and cargo in EV-(electronic) based embodiments. Unlike the internal combustion engine (ICE) involving the engine transmission, radiators, turbochargers, superchargers, and powertrain which can take up significant amounts of volume, the EV propulsion system can be implemented in a simpler manner and in some embodiments, EV propulsion need only include the electric motors, the battery pack, and the electrical interconnections and control circuitry, each of which can be arranged compactly in the front and rear quarter nodes 216 and 208 (FIG. 2) on the respective sides of the vehicle and the adjacent the underbody region underneath.

Regardless of whether ICE, EV, or hybrid propulsion systems are used, however, the parts that make up these systems, such as the electric motors, battery pack and the associated circuitry distributed within the vehicle can, in an embodiment, all be acquired as COTS parts. Accordingly, the use of the conventional platform obviates the need for the manufacturer to invest CapEx in tooling and machining equipment to assemble these structures from the ground up. Certain parts in FIG. 2, such as the extruded-A pillar upper 218, is a curved custom extrusion that can either be acquired from a supplier pursuant to specifications provided by the manufacturer, can be 3-D printed, or can be acquired as a COTS part such as carbon fiber part. If necessary in certain embodiments, the manufacturer can modify the COTS part in-house.

The vast majority of components illustrated in FIGS. 1 and 2 are COTS parts, with the principal exceptions being the nodes. For example, depending on the type of vehicle and the configuration, region 216 includes a 3-D printed front quarter node. The nodes can be visualized in part by referencing the 3-D metal texture 302 described in FIG. 3, and referring back to 216 and 208 of FIG. 2. The node may interface with an A Pillar lower (also in region 216) which, in turn, transitions into the front crash structure 104 (FIG. 1) and also provides attachments for suspension, steering, electric motor, the dash, foot-well, upper structure, hinges, door check front storage compartment, sill extrusion, and door seal (collectively region 216). Accordingly, the platform architecture militates in favor of the manufacturer acquiring these parts as COTS parts from a supplier (once they are suitably identified based on the design objectives) and 3-D printing the nodes to properly interface with the COTS parts.

Nodes. A node (e.g., FIG. 1 106, 110; FIG. 2, 3-D Printed Front Quarter Node (220), B Pillar Lower Node (Region 212), 3-D Printed Rear Quarter Node (208)) may be any 3-D printed part that includes one or more sockets, receptacles, recesses, cavities, or other interfaces for accepting one or more components such as tubes, extrusions and/or panels. The node may have internal features configured to accept a particular type of component and/or to route fluid or wiring between different interfaces. Alternatively or additionally, the node may be shaped to accept a particular type of component. A node in some embodiments of this disclosure may have internal locating features for positioning a component in the node's interface. However, as a person having ordinary skill in the art will appreciate upon review of this disclosure, a node may utilize any design or shape and may accept a variety of different components without departing from the scope of the disclosure.

In some embodiments, nodes may have additional features and structures to effect a particular function. For example, some nodes may include unique geometries or material compositions for handling different load bearing regions of the vehicle. These geometries may include lattices, honeycombs, and other types of patterned structures. Nodes may also include one or more channels for routing adhesive, sealant or negative pressure (vacuum) to and from one location to another. In other embodiments, multiple nodes may be co-printed and positioned adjacent one another in a desired portion of the vehicle.

Nodes may route electronic circuitry or lubricants from one structure (e.g., a tube) to another, (e.g., a gear case). The flexibility of nodes to accomplish these functions derives in large part from the non-design specific nature of the 3-D printer upon which the current platform is based. For example, using a computer-aided-design (CAD) program, a custom representation of 3-D node can be generated and designed to include unique shapes, interfaces, and other details. The CAD model can then be sliced to provide software-based layers of the original 3-D structure. The sliced model and printing instructions can then be provided to the 3-D printer. In a powder bed fusion (PBF) printer, for example, the slices are successively deposited as layers of powder on a substrate in a print chamber. One or more lasers or other energy sources may selectively fuse each layer or slice based on the custom instructions to render the designed node.

Nodes may be non-definition nodes or definition nodes. A definition node is described in more detail below. A non-definition node is any node that is not a definition node. For example, referring to the ref no. 220 in FIG. 2, where this structure is a 3-D printed B Pillar to Rail and thereby connects the B Pillars to the upper rails and roof, this AM structure in one embodiment is a non-definition node that functions to interface various COTS interconnects.

Referring back to FIG. 1, 104 was previously noted as a front crash structure. Adjacent the front crash structure is front tub 102. On the opposite side of the vehicle is rear tub 114, which may for example be used for cargo. Rear crash structure 112 is on each side of rear tub 114 (which is like front crash structure 104 in that the latter is disposed on each side of front tub 102). Front corner “steer” node 106 is just behind the front wheel. Floor structure 108 occupies the majority of the underbody. Rear corner “drive” node 110 occupies a periphery of the floor structure inside the front right wheel.

Referring to the side view of FIG. 2, region 216 as noted includes the A Pillar lower along with electronics, steering, suspension, and an electric motor, etc. The extruded front sill 214 may be a simple, straight custom extrusion that attaches to the floor and A and B pillars. B Pillar Lower Node 212 attaches to sills, the floor and the upper body structure. The extruded rear sill 210 is a simple, straight custom extrusion that attaches to the floor and B and C Pillars. In an embodiment, the 3-D printed rear quarter node 208 includes C Pillar lower which transitions into rear crash structure 112 (see FIG. 1), and provides attachments for the suspension, the electric motor adjacent its wheel, the upper structure, door latches, a rear storage compartment, sill extrusion and door seal.

FIG. 3 includes matching textures for identifying the materials of the various structures of FIGS. 1 and 2. For example, 302 is 3-D metal printed, 304 is high strength plastic, 306 is low strength, low cost tooling material, and 308 is COTS.

COTS parts. The complex structures illustrated in FIGS. 1-3 may be additively manufactured, to benefit from the non-design specific manufacturing capabilities offered by AM. Highly customized structures can be created using AM. As noted above, AM can be used in addition to, rather than as an alternative to, certain conventional techniques such as the use of commercial off-the-shelf (COTS) elements. Accordingly, in an embodiment, the platform relies on a significant number of COTS parts to enable making a wide range of vehicles.

AM is a valuable resource and its use is prioritized; thus, utilizing COTS parts means that any priority strain on the 3-D printer(s) can be effectively managed. In some embodiments, mass and material consumption of the AM parts can be minimized by including COTS parts with the design. COTS elements may also be inexpensive and readily available. COTS elements have typically known geometries with easily accessible specifications. Thus, wherever feasible, COTS elements may be ideal for incorporation in the manufacturing platform along with AM structures.

Use of COTS elements also eliminates the capital expenditures that would otherwise be required for the machinery and manpower to produce and assemble these structures in-house. The platform is predicated in part on the capability of the manufacturer to viably and timely produce a variety of models. Thus, acquiring COTS parts reduces the capital expenses that would be incurred for building the same parts in-house, rendering the COTS option generally desirable. In an embodiment, certain COTS parts can be acquired and modified to provide a custom design.

AM and Modularity. Additively manufacturing certain sections of the vehicle in accordance with the platform may enable modular construction and assembly of vehicles. Modular vehicles may be assembled by joining multiple discrete systems or components together to form one vehicle. Unlike conventional vehicles, modular vehicles provide the freedom of customizability. Complex parts and consoles can be removed easily, both for functional and aesthetic purposes, and new parts and consoles can be added in a straightforward manner. Because AM technologies are not tooling intensive, AM can be used to facilitate the development of modular systems by efficiently fabricating a variety of customized designs that maintain pace with customer requirements and demand.

AM also provides modular processes with the capability to define and build complex and efficient interfacing features that define partitions between modules. These features can include indentations, tongue and groove profiles, adhesives, nuts/bolts, and the like. A further advantage of implementing modular designs for use in vehicles is ease of repair. Modular designs ensure easy access to virtually any component in the vehicle. In the event of a crash, the affected modular block(s) can be replaced. The block(s) can also be co-printed with other blocks or structures to save assembly time. The blocks can further incorporate in-situ scanning and observation to ensure accurate joining and repair of the modules.

Using a modular design approach, the AM vehicle may be assembled as a collection of 3-D printed and non-printed components, including COTS components, integrated together via well-defined interconnection means for attaching the components at desired transitions. Individual components may be added and removed without requiring changes to other components in the vehicle. The use of the definition nodes as described below, in cooperation with the remaining non-definition nodes, enables the modularity of vehicles constructed using the platform.

In addition, modular design and assembly approaches make it possible for flexible manufacturing cells to be configured for assembly. Advantages include reduced reliance on fixtures during assembly (eventually complete elimination), lower assembly cell footprint in comparison to traditional assembly lines, etc.

Vehicle Sections. In an embodiment, having identified the desired vehicle profile and optionally mapped out the basic design requirements, the manufacturer may further break down the vehicle design into sections. One reason for breaking down the vehicle model into sections is to enable the manufacturer to delineate the COTS parts or functions from the non-COTS parts or functions. Another reason for the breakdown is to understand how, if at all, the parts in each section will ultimately interface or interconnect with one another. With this knowledge, the manufacturer can produce and assemble definition nodes as described in greater detail below.

In an embodiment, a number of vehicle sections may be equivalent to the number of wheels, although this need not be the case and other considerations may dictate that a greater or fewer number of sections are more suitable. In the case of a four-wheel vehicle, the manufacturer may elect to break into four (4), six (6) sections, for example. Each section may comprise one or more additively manufactured parts that can be configured to interface with COTS parts including, for example, suspension, wheels, electric motors, crash beams, pillars, and the chassis members. Accordingly, in this phase of the process, the manufacturer may consider and identify the different COTS structures that will likely reside in a section, and how these structures will be interconnected with which parts. Using this preliminary information, the manufacturer can further identify what functional and geometrical structures may be needed to accommodate each one of those interconnections in the relevant section.

In addition, the manufacturer may also need to consider other factors including anticipated temperatures/pressures in various parts of a section, estimated structural integrities and load-bearing capabilities in light of anticipated loads, crash regulations, material properties, weak and strong points in the vehicle design, and other factors. With this information, the manufacturer can identify an optimal structure, or collection of substructures, that can accommodate all of the necessary interconnections in light of the identified load and other requirements, for a section. The information obtained from this analysis can be used in the assembly of AM nodes for that section.

EV architectures. While the platform includes incorporating ICE architectures, which can be produced to the manufacturer's benefit using the principles described herein, ICE architectures tend to consume a significant portion of the vehicle's volume. As a result, ICE propulsion systems have historically been a constraint to automotive manufacturing. By contrast, integrating electric vehicle (EV) propulsion systems with AM structures dramatically reduces the CapEx and complexity of manufacturing automobiles. Unlike the internal combustion engines and systems that occupy a substantial portion of the front of the vehicle (and therefore place practical limitations on how the vehicle's space can be used), the electric motors may be placed immediately adjacent the AM nodes (below) that define the perimeter of the vehicle.

Further, as noted above, the battery pack may be placed in the vehicle underbody or floor. The hood area of the car can be effectively cleared for other uses as a result. Like ICE engines, transmissions, etc., EV propulsion systems (such as batteries, motors, wiring) can be procured as COTS members and can simply be integrated with the AM structures and other adjacent COTS members as necessary. The AM structures in these cases can be fabricated in a manner that easily accommodates these EV components. For example, to match the geometry and interface of a particular EV COTS part, such as a set of protrusions used to connect to the vehicle, a corresponding AM structure can be printed with apertures perfectly aligned to receive the protrusions such that the parts can be easily integrated together. Incorporating EV propulsion systems into the platform consequently has significant benefits. Therefore, for embodiments using EV propulsion systems, the platform accords significant flexibility to the manufacturer in vehicle design by providing more usable volume. Further, parts can be acquired and assembled quickly, and the availability of AM with the ubiquitous nature of COTS parts means that propulsion systems need no longer be a significant constraint to vehicle manufacturing.

Definition nodes. Definition nodes are so-called because they define the vehicle to be made. In an embodiment, the locations of the definition nodes may be determined by the internal volume requirements of the vehicle. For example, the definition nodes may be more closely spaced in a small hatchback car (owing to its small size), in comparison to a large sedan or SUV. In an SUV, by contrast, the nodes are farther away, both for nodes along a side of the vehicle and nodes on opposing sides. The definition nodes may be placed along the perimeter of the vehicle to enable the manufacturer to control the vehicle's internal volume. The platform's use of definition nodes advantageously removes the requirement of expensive tooling of vehicle parts to determine internal volume and the CapEx incurred with this former endeavor.

Once the locations are identified as described above, the definition nodes may be additively manufactured and, using the information and analyses above, the AM nodes may be uniquely configured to interface with COTS suspension components, electric motors, crash beams, side crash beams, pillars, and other panels or elements that define the chassis and the interior package volumes. The underbody (FIG. 1) may also comprise COTS panel(s), which can be cut to the required dimensions at the factory. The batteries to power the electric vehicle may be packaged and placed in a common underbody architecture, configured to interface with the definition nodes. The complex structures can be additively manufactured to benefit from the non-design specific manufacturing capabilities of AM. Mass and material consumption of the AM parts can be minimized by utilizing COTS elements. Additively manufacturing certain sections of the vehicle facilitates modular construction and assembly.

FIG. 4 depicts an exemplary layout of a vehicle with six definition nodes identified (401 through 406) using the principles described above. Using the concept of definition nodes, the vehicle may be broken down into sections. Thus, using FIG. 4 as an exemplary embodiment, a vehicle to be manufactured may be partitioned into six sections 401-406. In the case of EV propulsion, each section may comprise AM parts which may be configured to interface with suspension, wheels, electric motors, crash beams, pillars, and the chassis members. As discussed above, integrating EV propulsion systems with AM structures dramatically reduces CapEx and the complexity of manufacturing vehicles. As noted, the electric motors may be placed immediately adjacent the AM nodes. EV propulsion systems (e.g., batteries, motors, wiring, and the like) can be procured as COTS members and integrated with AM structures and other COTS structures.

In the embodiment of FIG. 4, the four-wheeled vehicle is broken down into six definition nodes. This architecture is similar to the vehicle in the embodiment of FIGS. 1 and 2, which also uses six definition nodes. For example, in the side view illustration of FIG. 2, the B-pillar lower node 212 is a definition node. Referring back to FIG. 1, nodes 1 and 2 and 5 and 6 border a respective wheel well. Nodes 3 and 4 border the pillar area between front and rear doors on both sides.

Referring back to FIG. 4, the definition node locations can be determined by the internal volume requirements of the vehicle. In the six-node vehicle of FIG. 4, the spacing of the definition nodes would likely be somewhere in between a smaller hatchback car and a larger sports utility vehicle, for example.

Definition nodes 401-406, in practice, may incorporate a variety of functions, or distribute similar functions among different sections. In an exemplary embodiment, a definition node includes a plurality of additively manufactured substructures connected together. Each substructure may be dedicated to a specific interface or function. The definition nodes 401 and 402, for example, may route fluids and circuitry to and from other COTS or AM parts. The definition nodes may serve additional and different functions. For example, definition nodes may include lattice structures to maximize strength-to-weight ratios based, e.g., on the anticipated loads the six section vehicle is expected to sustain over a period of time. Definition nodes 401-406, or portions thereof, may also be geometrically shaped to provide further support to the paneling with which it interfaces and to withstand structural loads. A definition node in some embodiments may include two or more co-printed substructure nodes, each substructure node used to interface with the same or different elements depending on the desired configuration.

Any of the definition nodes 401-406 may be connected to the vehicle using different methods. In one embodiment, the 3-D printed nodes are attached to the underbody panel, or floor structure. The definition nodes (e.g., 401, 402, 405, 406) may also connect to the front and rear crash structures. The same four definition nodes may also be coupled to the suspension components, such as the control arms and struts. The definition nodes, as noted above, also interface with many or most of the COTS parts that will reside in the particular section with which the definition node is associated.

As is evident from the illustration of FIG. 4, once the definition nodes are located, the interior volume of the vehicle is known and the relative positions of additional structures are well-defined. All other panels and parts can then be positioned relative to the known definition nodes 401-06. Precisely because most or all of these parts depend on the positioning of the definition nodes, this factor can be of particular importance in the initial construction phase of the vehicle. Accordingly, in an additional embodiment, the platform may employ a dedicated automated system to calibrate and fix the location of the definition nodes relative to each other. In certain embodiments, robots or other automated constructors may be used for this purpose. Once the definition nodes are fixed on the assembly fixture and their position is measured to within the predetermined degree of confidence, the remaining portions of the vehicle may be assembled as a collection of modular blocks. The assembly can be manual or alternatively it can be automated, in part or in whole.

While some embodiments of the platform may dictate that the design and positioning of the definition nodes be performed first, in other embodiments involving EV propulsion systems, the battery pack may be first assembled. In general, however, the design and preparation of the definition nodes is prioritized, because after these nodes are positioned and fixed, the majority of the remaining tasks tend to fall into place.

The panels and structures used to connect to the definition nodes generally need to be machined for precision. A significant advantage of the platform is that the machining tasks can be performed by the COTS supplier—not the vehicle manufacturer. Thus, the manufacturer may be spared from having to make significant capital expenses to fund the tooling required for these tasks.

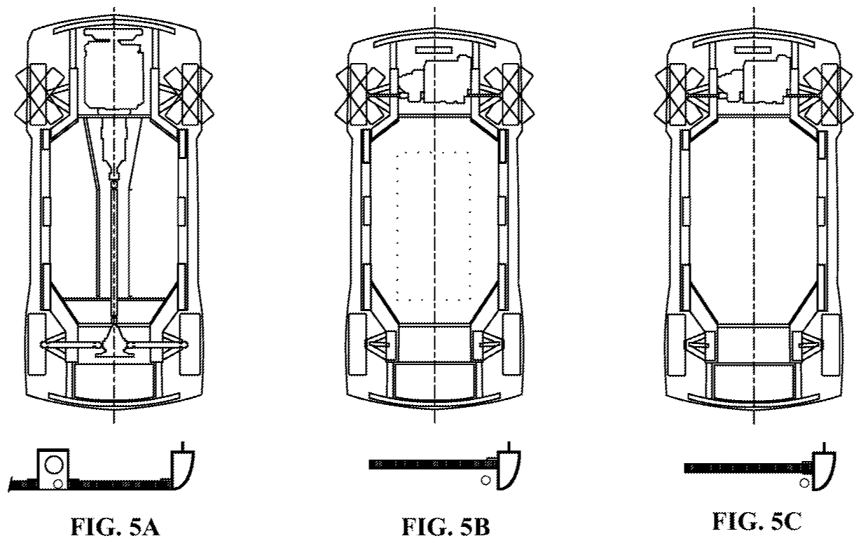

In scenarios where hybrid/internal combustion engine (ICE) vehicles are to be manufactured, the internal volume requirements may factor in packaging volumes to accommodate the ICE, transmission, drive shaft, and other components that may be unique to, or more pronounced in, hybrid or ICE designs. FIGS. 5A-C illustrate three examples of different vehicles for which internal volume requirements may differ based on packaging volumes used to accommodate the particular vehicle. In particular, FIG. 5A represents an ICE-based vehicle having a longitudinal front engine and rear wheel drive. FIG. 5B represents a hybrid vehicle having a transverse engine and front wheel drive. FIG. 5C represents a hybrid front wheel drive vehicle with a transverse engine. In scenarios such as in FIGS. 5A-C where hybrid/ICE vehicles are to be manufactured, the internal volume requirements may factor in packaging volumes to accommodate the ICE, transmission, drive shaft, and other components.

The illustrative examples of FIGS. 5A-C show that many or most of the platform architecture's advantages also extend to the ICE and hybrid configurations. While additional volume is generally required for accommodating the engine, different configurations can save volume in other areas. For example, the drive shaft of FIG. 3A can be eliminated where front wheel drive is employed. The engine sizes between the front, hybrid and transverse engines may also vary. Application of the platform architecture to construct these vehicles using definition nodes and AM is unique and adds many of the same benefits for creating a large portfolio of different vehicles.

The definition node(s) can include connection interfaces to connect to a plurality of parts. For example, the definition node itself may be broken down into multiple components and connected to each other. The definition nodes may be connected to the dash and floor panels utilizing node-to-panel connection features enabled by adhesives. The node may connect to the crash structures (front crush rail) using mechanical fasteners, which may include nuts, bolts, screws, clamps, or more sophisticated fastening mechanisms. The node may utilize adhesive connections, mechanical fasteners, or a combination of both to connect to extrusions. Additively manufacturing definition nodes can enable the platform to create optimized structures in either a single manufacturing operation not requiring any machining or requiring minimal machining operations upon completion of the printing.

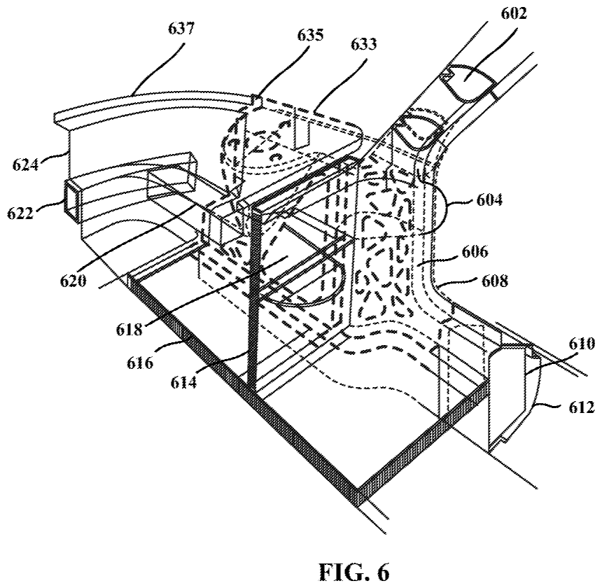

FIG. 6 shows a perspective cross-section view of a definition node (shown generally in dashes or circular dashes) coupled to adjacent components in a vehicle according to an embodiment. FIG. 6 shows, in particular, a right-front (passenger) cross-section of a vehicle, with the cargo area in front in lieu of a front internal combustion engine. As demonstrated above, the platform provides the capability to identify and additively manufacture foundational blocks (definition nodes) 633 of a vehicle. In FIG. 6, the Cowl/IP armature panel 604, which includes the glove compartment, can be seen directly affixed to the definition node 633. The A-Pillar Upper 602 is made of formed extruded aluminum in this embodiment. The A-Pillar Upper 602 defines the perimeter of the door portion, extends to the roof, and is coupled to the definition node 633 closer to the vehicle edge. The floor panel cross-section 616 may define the entire area or a substantial area of the floor and can be connected to the definition node 633 in a straightforward manner, e.g., using a node-to-panel connection with an adhesive. The floor and dash panels in this embodiment are honeycomb sandwich panels that are common COTS parts.

Front crush rail 620 is coupled to definition node 633, as is front cargo tub 624. In an embodiment, front crush rail 620 is composed of extruded aluminum. Hood seal flange 637 is a vertical flange that follows the top of the front cargo tub 624. Strut tower 635 is part of the definition node 633 and interfaces with front cargo tub 624 and hood seal flange 635. Definition node 633 further includes a node material reduction panel 618, which may be a composite honeycomb sandwich panel. Dash panel 614 is shown in cross-section and may also be a honeycomb sandwich panel.

Cowl/IP armature panel 604 may interface with a vertical portion of the definition node 633. Also shown is the front quarter node 606, which in this embodiment is an integral part of, and co-printed with, definition node 633. Adjacent front quarter node 606 is door seal flange 608. Toward the rear of the drawing is sill 610, which may constitute extruded aluminum. Sill cladding 612 is connected to sill 610. Sill cladding can, in an embodiment, be constructed using low cost tooling.

The definition node 633 of FIG. 6 is representative in nature and is not intended to limit the scope of the disclosure. For example, in other embodiments, many of these components connected to or otherwise associated with definition node 633 can be acquired as COTS parts or alternatively, they can be 3-D printed. In many cases, the honeycomb sandwich panels can be cut and machined at the supplier's facilities per the manufacturer's specifications. In still other embodiments, different parts may be co-printed with definition node 633. Also, machining and other conventional techniques may still play a role, albeit usually a more limited one, in constructing components such as the sill cladding 612. In general, using the platform as disclosed herein, a large number of different configurations and embodiments may be contemplated that rely principally on 3-D printed definition nodes and COTS parts.

In short, once the nodes are manufactured, COTS panels, extrusions, tubes, and other parts can logically be connected to form interfaces with the nodes. Node-based modular construction methods provide the ability to realize multi-material connections, which are paramount in meeting strength-to-weight metrics for automobiles and other complex transport structures. Furthermore, galvanic isolation may be provided between galvanically incompatible materials being connected by utilizing nodes to include isolators to space and prevent physical contact between the dissimilar materials.

The platform enables a common architecture for manufacturing a plurality of vehicles. The platform may include additively manufactured definition nodes, which may be assembled with EV/hybrid powertrain components, tubes, extrusions, panels, roof structures, and other components. Furthermore, this platform enables maximization of the available internal volume for occupants and cargo. By utilizing definition nodes and controlling their location, a vast product portfolio enabled by a single platform is possible. The platform also enables the creation of smaller footprint factories to manufacture an entire portfolio of vehicles, as noted above. Since this platform relies on the marriage between additive manufacturing and COTS elements, with potentially limited (if any) use of conventional manufacturing techniques, it can enable the creation of distributed production units all over a geographic area of interest configured to run in parallel, that are not susceptible to the production halts prevalent in traditional vehicle assembly lines.

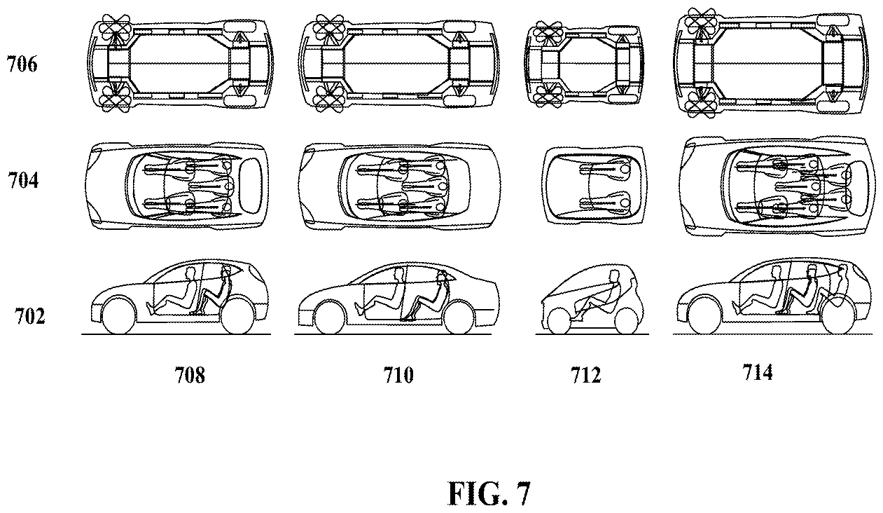

FIG. 7 shows different product portfolios that may be built using the platform herein-described, governed by factors like underbody construction and vehicle size. FIG. 7 illustrates, in particular, four different types of vehicles that are possible by selecting and positioning AM definition nodes. The vehicles in FIG. 7 are arranged as four columns and three rows. Each column represents three different views of a single vehicle. Column 708 illustrates a mid-size sports utility vehicle (SUV). Column 710 represents a large sedan. Column 712 represents a small autonomous taxi. Column 714 represents a large SUV. Row 706 illustrates the underbody of each respective vehicle in a column. Similarly, row 704 illustrates a top down view of each such vehicle. Row 702 illustrates a side view of each vehicle.

It should be noted that the four vehicles shown are a very small representation of the different possible vehicular configurations that can be implemented using the current platform. The manufacturer is no longer limited to producing a single model due to limitations inherent in the conventional assembly-line approach. In other embodiments, large vans and multi-person transports can be assembled using the platform as described herein. In still other embodiments, by positioning the definition nodes accordingly, vehicles can be made very wide, very narrow, long, short, high, low, or somewhere in between any or all of these parameters.

FIG. 8 is a representative example of a definition node coupled to a wheel in a steer/drive configuration. Space 2510 is the storage compartment, and represents saving of space for cargo by judiciously packaging the EV elements. Honeycomb sandwich panel 2508 is shown extending into a receiving member 2512. The body of the node 2506 is coupled on one side to front fender panel 2502. The lower portion of node 2506 is coupled in this embodiment to a McPherson Strut Suspension 2504 with integrated electric drive. The electric motor 2514 can be seen compactly packaged in the underbody and packaged adjacent node 2506. Other embodiments are equally possible depending on the type of vehicle, the mechanism of propulsion, etc.

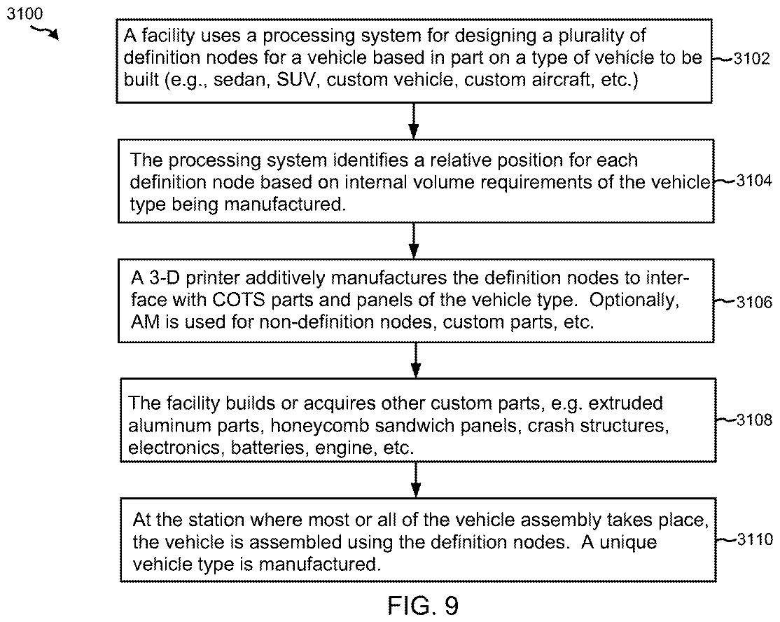

FIG. 9 shows an exemplary flow diagram of a process 3100 used by a facility to manufacture different types of vehicles in accordance with an embodiment. As used herein, a facility is a factory, whether self-contained or as a separate location in a building. The facility may be as small as one room, or alternatively, it may be a larger and more sophisticated facility or warehouse with a plurality of stations. As used herein, a station is a location where the vehicle or other transport structure is assembled. The station may or may not include automated robots and one or more 3-D printers. The station may simply be a room with a location (e.g., a vehicle holding structure or platform) where a vehicle is under assembly. The station may or may not use a rack, or a horizontal or vertical cell to stabilize the vehicle while it is under assembly. In more sophisticated embodiments, the station may be serviced by robots or other automated constructors. The station may include one or more 3-D printers. Alternatively, the 3-D printer(s) may be in a different room. The station may have areas to store COTS parts and facilities to make custom parts or to machine parts. For example, the station may include an extruder for extruding aluminum pillars for vehicles. In other embodiments, the inventory and manufacturing equipment may reside in another location. In short, the facility and the station are intended to be construed broadly, and a large number of alternative configurations are possible.

The facility may or may not include a central controller. The facility generally includes various types of computers and controllers—collectively referred to herein as a processing system—that design engineers and other staff are assigned to perform design work in computer-aided-design (CAD) software or any other software. The processing system may or may not include a plurality of computers, servers, workstations, and/or handheld devices, any or all of which may be connected via some type of network. In more sophisticated configurations, a central controller may be used to automate, partially or otherwise, the activities at the facility. The central controller may in such embodiments be configured to direct the actions of different devices including robots, inventory-transporting vehicles used at the facility for moving parts, and/or 3-D printers. In simpler embodiments, the processing system may not include a central controller or servers, but may contain one or more PCs or workstations. In other embodiments, the processing system includes dedicated hardware components such as field programmable gate arrays (FPGA), digital signal processors (DSPs), and the like. In general, as used herein, a processing system refers to one or more processors coupled to memory for use in executing computer algorithms for the purpose of designing and building vehicles as described herein.

The processing system may include the electronics associated with the 3-D printers.

A processing system may, but need not, include one or more general purpose computers. In an embodiment, the processing system incorporates within its scope software and firmware used at the facility, including CAD algorithms and other design software. The processing system may include software for manipulating fixtures and operating an assembly cell, for example, in more sophisticated facilities.

Referring now to FIG. 9, at step 3102, a facility uses a processing system as described above for designing a plurality of definition nodes for a vehicle based in part on the vehicle type to be manufactured. These may include SUVs, sedans, vans, minivans, roadsters, wagons, trucks, pick-ups, off-road vehicles, etc. Within these and other categories, different sizes, shapes, models and configurations may be specified. Different accessories, options, and packages may be included or excluded. Aircraft may be included by simply positioning definition nodes in appropriate locations such as adjacent the wings, tail and body, for example, as would be known by one skilled in the art based on a review of this disclosure.

At step 3104, the processing system (or more precisely, the individuals conducting the design work via the processing system) identifies a relative position for each definition node based on internal volume requirements of the vehicle type being manufactured. Because the relative position of the definition nodes is defined using custom or off-the-shelf software or similar techniques, the need for complex tooling and expensive machining operations that are used by existing auto-makers can be largely or entirely eliminated.

At step 3106, the definition nodes are additively manufactured. This operation may be conducted at the facility. Alternatively, the facility may provide the CAD files or SLA files (or other 3-D printing specifications) to a contractor, partner, or other entity to perform the 3-D printing on behalf of the facility. In an embodiment, the facility includes one or more 3-D printers. The definition nodes are precisely 3-D printed to include custom interfaces to COTS parts, extruded parts, panels, and other hardware. In addition, the 3-D printers may optionally be used to print non-definition nodes for the vehicle, as well as other custom parts. COTS parts may generally be acquired cheaply from vendors, but in certain situations they may be 3-D printed or otherwise built at the facility using conventional techniques.

At step 3108, the facility may build or acquire other custom parts such as extruded aluminum parts (or other materials), sandwich panels, crash structures, electronic wiring, electronic motors, batteries, engines, hoods, etc. These parts may be custom formed, 3-D printed, cheaply tooled, or purchased from a vendor. In an embodiment, most of these parts are COTS parts and are acquired as such. They are subsequently designed to interface with various parts of the vehicle, including definition and non-definition nodes that were customized via AM to interface with this equipment. Panels may be molded, stamped, 3-D printed, or otherwise acquired and machined to specification by the supplier. Generally, the steps are such that much of the highly-precision machining is rendered obsolete or performed by a third party. Sandwich panels may be made in-house or acquired and cut to interface with the manufacturer's nodes to form the vehicle underbody and other structures, such as the dash panel. These examples are non-exhaustive, and other configurations may be equally suitable. At step 3110, the vehicle is assembled using the definition nodes. A unique vehicle type can be manufactured. Thereafter, a different vehicle can be manufactured at the same station.

In an embodiment, a manufacturer may have two or more facilities, or a larger number thereof, distributed throughout generally different geographical regions. Each facility may be configured to design and manufacture vehicles using similar techniques as above. One advantage of this technique is that, if one facility encounters some sort of unanticipated impediment, (e.g., an error in the processing system, a malfunctioning printer, an overflow in work orders, etc.) then ideally another facility can be commissioned to build the vehicle on behalf of the facility with the impediment. This practice is in contrast to the singular assembly lines of the major vehicle and aircraft manufacturers, which generally have little recourse in the event of such impediments except to correct them at the assembly line or wait them out, as applicable.

The previous description is provided to enable any person skilled in the art to practice the various aspects described herein. Various modifications to the embodiments presented throughout this disclosure will be readily apparent to those skilled in the art, and the concepts disclosed herein may be applied to other techniques for the customized assembly of vehicles using definition nodes. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method for manufacturing a vehicle, comprising:
designing a plurality of definition nodes for the vehicle;
identifying a relative position for each definition node;
additively manufacturing the definition nodes; and
assembling the vehicle with the definition nodes in the identified positions.

2. The method of claim 1, wherein the positions define a vehicle profile comprising one or more modular systems.

3. The method of claim 1, wherein the positions are based at least in part on one or more internal volume requirements of the vehicle.

4. The method of claim 1, further comprising, upon identifying the position for each definition node;
designing or acquiring a plurality of panels and vehicle parts; and
identifying a position of the panels and vehicle parts relative to the position of each definition node.

5. The method of claim 1, further comprising:
designing the vehicle to include a plurality of commercial off-the-shelf (COTS) parts;
designing the definition nodes to interface with the COTS parts to produce modular features; and
manufacturing the vehicle incorporating the COTS parts and the modular features.

6. The method of claim 1, further comprising:
identifying an electric vehicle (EV) propulsion system for use in the vehicle; and
identifying the location of each definition node based at least in part on a desired position of elements of the EV propulsion system.

7. The method of claim 5, wherein the COTS parts and definition nodes are further used to manufacture a multi-material vehicle.

8. The method of claim 6, further comprising:
manufacturing the vehicle to incorporate the EV propulsion system.

9. The method of claim 1, further comprising:
manufacturing a plurality of vehicle types, each vehicle type manufactured based in part on
designing a set of definition nodes,
positioning the definition nodes in the set based on one or more internal volume requirements for each vehicle type,
additively manufacturing the set of definition nodes for each vehicle type, and
assembling a desired vehicle based on the position of the definition nodes.

10. The method of claim 9, further comprising:
acquiring a plurality of commercial-off-the-shelf (COTS) parts for the desired vehicle; and
interfacing one or more of the definition nodes with at least one of the COTS parts.

11. The method of claim 1, wherein the vehicle comprises at least one non-definition node.

12. The method of claim 10, further comprising:
identifying an electric vehicle (EV) propulsion system for use in the vehicle; and
identifying the position of each definition node in the set based at least in part on a desired position of elements of the EV propulsion system.

13. A facility for manufacturing a plurality of vehicle types, comprising:
(i) a processing system configured to
design a definition node for each section;
identify a relative position for each definition node;
(ii) at least one 3-D printer configured to additively manufacture the definition nodes; and
(iii) a station for manufacturing one of the plurality of vehicle types using the definition nodes in the identified positions.

14. The facility of claim 13, wherein the processing system is configured to identify a plurality of commercial-off-the-shelf (COTS) parts for interfacing with one or more of the definition nodes.

15. The facility of claim 14, wherein the station is configured to manufacture one of the plurality of vehicle types using the COTS parts.

16. The facility of claim 13, wherein the processing system is further configured to design an EV propulsion system for use in one of the plurality of vehicle types.

17. The facility of claim 16, wherein the station is configured to manufacture the one of the plurality of vehicle types using the EV propulsion system.

18. A system of geographically distributed facilities for manufacturing a plurality of respective vehicle types, each facility comprising:
(i) a processing system configured to
design a plurality of definition nodes for a vehicle;
identify a relative position for each definition node;
(ii) at least one 3-D printer configured to additively manufacture the definition nodes; and
(iii) a station for manufacturing one of the plurality of vehicle types using the definition nodes in the identified location.

19. The system of claim 18, wherein:
the processing system is configured to identify a plurality of commercial-off-the-shelf (COTS) parts for interfacing with one or more of the definition nodes;
the station is configured to assemble one of the plurality of vehicle types using the COTS parts and the definition nodes; and
the assembled one of the vehicle types comprises one or more modular features.

20. The facilities of claim 18, wherein one facility is configured to design a desired vehicle on behalf of another facility in the event of an impediment at the another facility.
